(19) United States
(12) Patent Application Publication
(10) Pub. No.: US 2007/0272467 A1
(43) Pub. Date: Nov. 29, 2007

(54) Motorcycle frame adapter

(76) Inventor: William Soileau, Nashville, TN (US)

Correspondence Address: LAW OFFICE OF CRAIG BOHN, 2134 BRANARD STREET, HOUSTON, TX, 77098, US

(21) Appl. No.: 11/701,645

(22) Filed: Feb. 2, 2007

Related U.S. Application Data
(60) Provisional application No. 60/764,711, filed on Feb. 2, 2006.

(51) Int. Cl. B62K 11/02

(52) U.S. Cl. 180/227; 29/402.03

(57) ABSTRACT

An adapter (30) for a motorcycle frame (10) configured with a vertical suspension system, as in Harley-Davidson® Sportster®, Dyna®, FXR™ and Road King™ style motorcycles that widens the shock (16) upper attachment points in order to permit the installation of a wider rear wheel. The adapter (30) is configured to attach at the original shock frame attachment point, secured in place by a replacement shock attachment bolt (18′) that is longer than the original shock bolt (18). The structure of adapter (30) provides support against the increased torque of weight on the shock (16), due to the additional length of the bolt, and adapter (30) is correspondingly recessed to closely fit over the junction area (J) of the frame's (10) generally horizontal member (12) and riser (14), so as to resist rotational torques that may be applied to fender, selectably mountable on replacement struts (21).

### CROSS-REFERENCE TO RELATED APPLICATIONS

This application claims the benefit of U.S. Provisional Application No. 60/764,711, filed Feb. 2, 2006.

### BACKGROUND OF THE INVENTION

1. Field of Invention

This invention relates generally to kits and components thereof for retrofitting motorcycle factory frames with wide rear tires. Specifically, this invention relates to such kits and components for retrofitting such frames configured as in a Harley-Davidson® Sportster®, Dyna®, FXR™ and Road King™ style motorcycle to allow for safe, simplified and expedient mounting of a wide rear tire.

2. Related Art

It is known in the art that wider rear tires can be installed by modifying a rear swing arm for a motorcycle's rear wheel. Manufacturers typically use a swing arm structure that fits between the stock frames then spreads outward from that point back to accommodate the wider tire, which include tires in excess of 130 mm wide. The motorcycle manufacturer, Harley-Davidson®, has a number of motorcycle models where the rear tire suspension consist of a shock absorber attached on each side of the tire and frame, positioned generally upright, with one end anchored to the axle and the other end anchored to the frame. For the shocks to operate properly for an extended period of time, the shock attachment points must be in the same plane with the force of gravity on the mass of the motorcycle. Since the tire must fit between the shocks, the potential width of the tire that can be installed is therefore limited by the width of the shock attachment points. Stock tires may vary in size.

The Soileau U.S. Pat. No. 6,230,837 patent discloses a single piece swing arm that compensates for a wider tire in order to achieve a true centerline configuration in a motorcycle configured like a Harley-Davidson® Sportster®. The disclosed swing arm spreads the shock attachment point at the axle in a manner that can be employed with the current invention, but the shock's frame attachment point is spread in that disclosure by cutting the spanner bar between the two sides of the frame, spreading the sides of the frame, and then installing an extension to the spanner.

Another method of spreading the shock's frame attachment points includes welding a wider portion to each side of the frame at the shock's original frame attachment points, such wider portion has a new frame attachment point, as well as a new strut to support a wider fender, since the old strut would need to be cut off to get it out of the way of the new wider tire. This technique takes a substantial amount of time for a skilled welder to make sure the parts all fit properly and provide precise positioning of the new attachment points for the shocks and struts. Additionally, welded bonds are difficult to thoroughly inspect to ensure their sound integrity.

It would therefore be a new and useful improvement over the prior art to have a frame adapter that fits to the frame at the shock's original frame attachment point, being secured by a longer shock bolt, which may provide for the mounting of a replacement strut, and displaces the shock's frame anchor point to a wider position that corresponds to a wider shock swing arm attachment point, while at the same time providing adequate support against the increased torque on the frame, adapter and shock anchor bolt, due to moving the shock anchor point further away from the center of the frame. It would be an improvement that the device may be assembled using a single shock bolt that can be properly torqued for a confirmed secure fit, and which avoids any drilling of the frame that may weaken the structure. It would be an improvement that the device permits a wide-tire conversion process to take place in a short amount of time, with a minimum of specialty equipment and skills. It would be an additional improvement to the field to provide a modification kit, including left-side and right-side frame adapters, and a suitably extended shock bolt. An additional kit could also include a pair of replacement struts that bolt to the adapter. An additional kit could also include a replacement rear swing arm having an increased width corresponding to the width increase provided by that particular kit's adapters.

### BRIEF SUMMARY OF THE INVENTION

My invention is an adapter for a motorcycle frame configured with a generally vertical suspension system, as in Harley-Davidson® Sportster®, Dyna®, FXR™ and Road King™ motorcycles. The adapter may be attached at the original shock frame attachment point, secured in place by a replacement shock attachment bolt that is longer than the original bolt. The structure of the adapter provides adequate interface with the original frame so as to prevent movement under loads, which may be applied to either or both the suspension system and rear struts during operation of the modified motorcycle.

Accordingly, objects of my invention are to provide, inter alia, a motorcycle frame adapter, adapter kit and motorcycle wide-tire conversion process that; simplifies and shortens the time of the conversion process; supports a tire wider than a stock tire; and enables one with routine mechanical skills and equipment to perform the conversion. Other objects of my invention will become evident throughout the reading of this application.

### BRIEF DESCRIPTION OF THE DRAWINGS

FIG. 1 is a side view of a motorcycle having a rear wheel suspension system using a generally upright shock absorber of the prior art.

FIG. 2 is a side view of an installed exemplary inventive adapter.

FIG. 3A is a side view of the upper frame junction area of the prior art frame shown in FIG. 1.

FIG. 3B is a perspective view of the upper frame junction area of an alternative embodiment of the prior art motorcycle frame.

FIG. 4 is a perspective view of an exemplary inventive right-side adapter and replacement strut.

FIG. 5 is an inside side view of an exemplary adapter.

FIG. 6 is an inside side view of an alternate exemplary adapter for a differing motorcycle model.

FIG. 7 is an outside side view of the exemplary adapter shown in FIG. 5.

FIG. 8 is an outside side view of the exemplary adapter shown in FIG. 6.

FIG. 9 is a generally front perspective view of an exemplary adapter.

FIG. 10 is a generally front perspective view of an alternate exemplary adapter.

FIG. 11 is a generally front perspective view of an additional alternate exemplary adapter.

FIG. 12 is a generally rear and top perspective view of alternate exemplary adapters of differing widths and for differing motorcycle models.

### DESCRIPTION OF THE INVENTION

It should be understood that the following terms, as used herein, are defined as follows: “leading edge” or “front” means the part of the object that when integrated into the motorcycle would face the direction of forward travel of the motorcycle; “trailing edge” or “rear” means the part of the object that when integrated into the motorcycle would face away from the direction of forward travel of the motorcycle; “inside,” “outside,” “inner,” and “outer” used in reference to components, or parts thereof, as being toward the center of the motorcycle or away from the center of the motorcycle, respectively. The terms “upper,” “lower,” “top,” “bottom,” “left” and “right” are used from the viewpoint of a person positioned to operate the motorcycle and the motorcycle being in an upright position. A generally vertical suspension system is where a rear shock absorber has one attachment point that is higher than the other attachment point, and the linear shock absorber body is upwardly angled from the horizontal, as reference on a motorcycle that is in the upright, operating position.

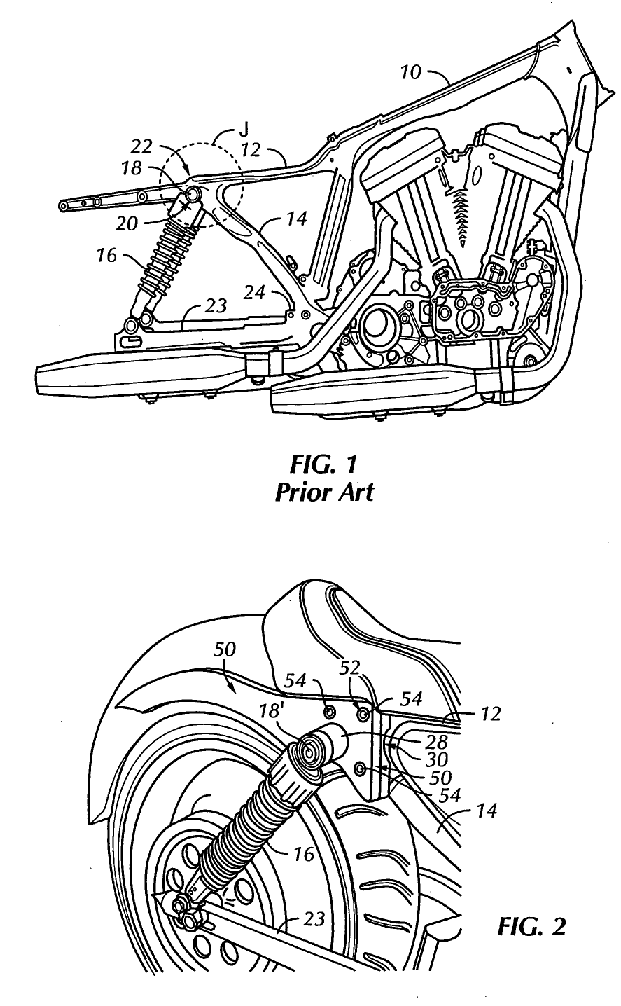

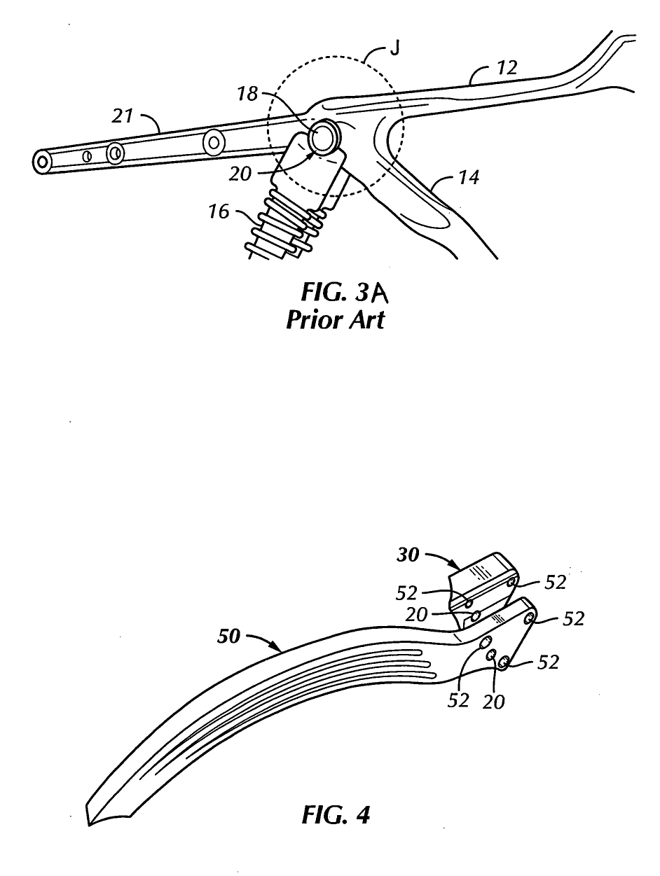

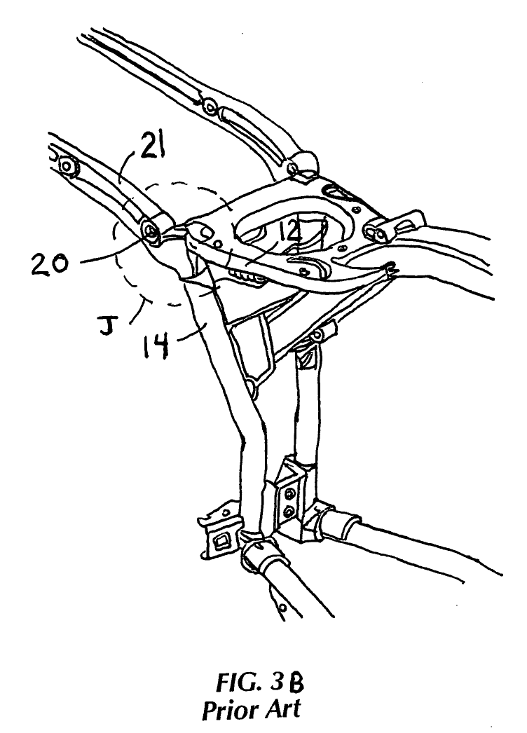

Referring to the drawings by numerals of reference, FIGS. 1, 3A and 3B illustrate examples of the prior art motorcycle frame 10 upon which the current invention may be applied. Of particular concern is frame junction area J toward the rear or trailing end of the frame 10, where a generally horizontal member 12 on each side of frame 10 joins with a respective frame riser 14 coming up from the bottom of frame 10 on both sides. The particular frame 10 shown in FIG. 1 is to a Harley-Davidson® Sportster®, which means specific things to one skilled in the art. The current invention can be used with any frame that has the configuration of the generally horizontal member 12, riser 14 and generally vertical shock 16 anchored in the junction area J of horizontal member 12 and riser 14.

FIG. 3B illustrates an example of a frame known as a Dyna® series motorcycle frame. Since Sportster® frames, Dyna® frames, FXR™ frames, and Road King™ frames mean specific details to one skilled in the art, the specific designs of various year model frames as produced by Harley-Davidson®, including Sportster®, Dyna®, FXR™ and Road King™ frames, are hereby included by reference. Other motorcycle frames may be patterned after these frames, and may fall under the scope of this disclosure.

For simplicity of discussion only the components on the one side of the motorcycle shown may be discussed, but unless expressly stated, mirror images of the components exist on the other side of frame 10, as is readily understandable by one skilled in the field of art. A tire (not shown) may be attached to frame 10 with swing arm 23, which in turn is pivotally attached to frame 10 with swing arm bolt 24. Shock absorber or shock 16 is attached at the lower end to swing arm 23 and at the upper end with shock bolt 18 to a shock bolt hole 20 in junction area J. Junction area J is an important structural area of frame 10, because the entire weight on the rear end of the motorcycle, passenger and any cargo rests on the rear shocks through these points.

FIG. 2 shows an exemplary adapter 30 installed on a Sportster( frame 10 at junction area J. An additional bushing 28 has been inserted on replacement shock bolt 18′, in between the upper connection on shock 16 and adapter 30. Bushing 28 provides additional displacement of shock's 16 anchor point without making adapter 30 excessively thick. Bushing 28 is of a large enough diameter cylinder to provide adequate torsional support between shock 16 and adapter 30 to prevent excessive lateral torque being applied to replacement shock bolt 18′. As compared to the prior art configuration of FIG. 3A, shock 16 is still in the same general orientation. It is simply displaced outwardly away from the center of frame 10. In both prior art and inventive embodiments the shock's 16 upper anchor point still aligns with shock bolt hole 20 injunction area J.

FIG. 4 shows an adapter 30 adjacent to, but separate from a replacement strut 50. Strut bolt holes 52 align, as well as shock bolt hole 20. In the exemplary embodiment, strut bolts (not shown) are to pass through strut bolt holes 52 in strut 50 and seat in threaded strut bolt holes 52 in adapter 30. Though this is the preferred method, other equivalent means of fixing replacement strut 50 to adapter 30 are encompassed by this invention, where strut bolt holes 52 may be other forms attachment points for securing the strut to the adapter.

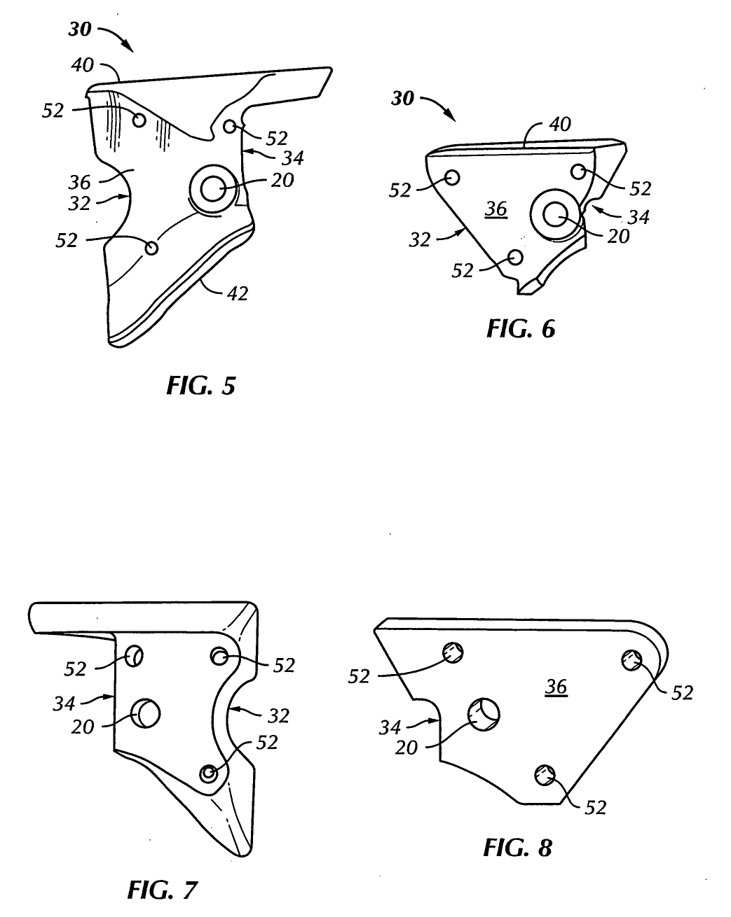

FIGS. 5 and 6 show the inside surfaces and FIGS. 7 and 8 show the outside surfaces 38 of two exemplary adapter 30 for the right side of differing year models of Sportster® motorcycles. FIGS. 5 and 6 show recess 36 that is formed to closely correspond to the shape of the junction area J on its particular motorcycle. Upper shoulder 40 is shaped to form a wrapping support around a horizontal member 12 of the motorcycle on which it would be installed. Similarly, lower shoulder 42 shaped to form a wrapping support around riser 14 of that motorcycle. Upper shoulder 40 and lower shoulder 42 diverge toward the leading edge 32 and converge toward the trailing edge 44 of adapter 30. This corresponds to the angle at which the respective horizontal member 12 and riser 14 converge into junction are J.

Adapter 30 may be secured in place by the installation of shock 16 with a suitably longer replacement shock bolt 18′ through shock bolt hole 20. Replacement struts 50 may be attached to adapter 30 to support a new wider rear fender (not shown). Also referring to FIG. 2, in the exemplary embodiment strut bolts 54 are inserted through strut bolt holes 52 to seat in corresponding strut bolt holes 52 in adapter 30. The firm fit of recess 36, supported by upper shoulder 40 and lower shoulder 42 being biased against horizontal member 12 and riser 14, respectively, secures adapter 30 in place sufficiently to safely withstand operational torque on shock bolt 18′, and torque that may be placed on replacement struts 50.

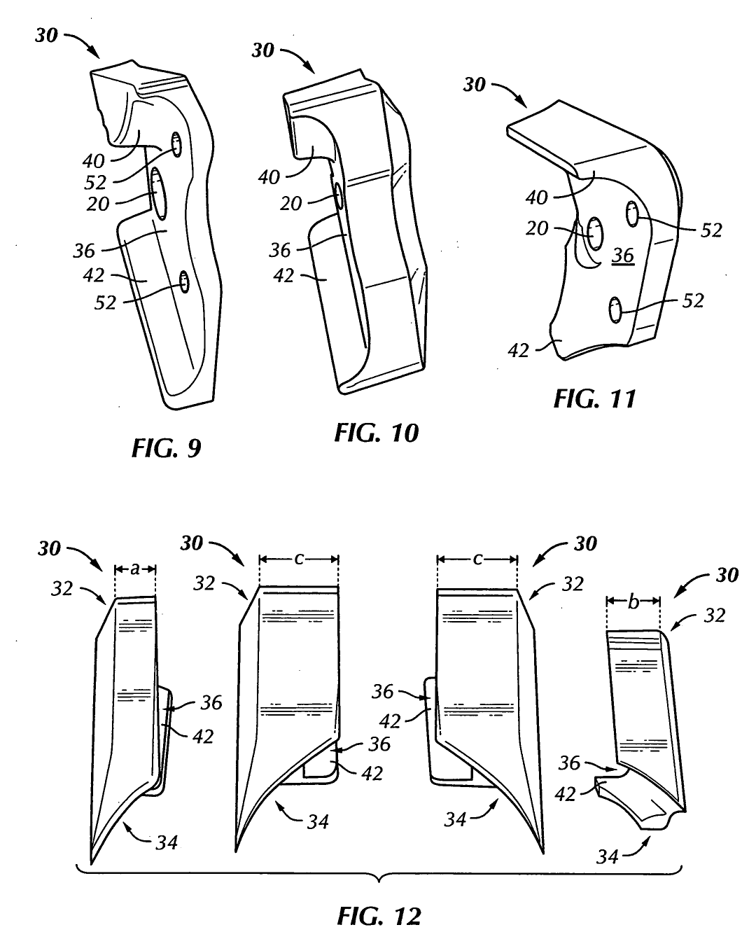

Referring to FIGS. 9 through 12, various widths a, b, and c adapters 30 may be used in order to attain the desired displacement of the upper attachment point of shock 16. Adapter width is determined by the amount of desired displacement that is needed for the particular model of motorcycle. FIG. 9 shows an exemplary left-side adapter 30 for an earlier year model Sportster® frame 10. The appropriate right-side adapter 30 would be a mirror image of the shown adapter 30. FIG. 10 shows an exemplary wider left-side adapter 30 for the same year model Sportster® frame 10 as shown in FIG. 9. The comparative difference in width is shown in FIG. 12 at widths a and c. The corresponding right-side adapter 30 for the adapter 30 shown in FIG. 10, shown on the center-right in FIG. 12, is a mirror image of the left-side adapter 30, shown by itself in FIG. 10 and on the center-left in FIG. 12. FIG. 11 shows an exemplary left-side adapter 30 for a late year model Sportster® frame 10. The appropriate right-side adapter 30 would be a mirror image of the shown adapter 30. On the late year model Sportster® frame 10 the junction area J is more compact, so the overall size of the corresponding adapter 30 may be smaller. The comparative width of this embodiment of adapter 30 is shown in FIG. 12, at width b.

Adapter 30 is designed to particularly match the junction area J of a particular model and type of motorcycle. Recess area 36 must appropriately compliment the particular junction area J, so that shoulders 40 and 42 properly bias against frame 10. Referring to FIGS. 9 through 12, in a similar way the width a, b, and c of a particular adapter 30 must correspond to the length of the replacement shock bolt 18′ to be used, as well as the width of the replacement swing arm (not shown).

Referring to FIGS. 1 through 4, to install adapter 30, the project motorcycle (not shown) will be prepared for the conversion by removing items that will interfere with the task, such as the rear wheel and the brake caliper. The existing shocks 16 are removed from left and right junction areas J by removing shock bolts 18 from shock bold holes 20 in frame 10. Existing struts 21 will be in the way of the new wider wheel, so both left and right struts 21 need to be removed just to the rear of junction area J, being careful to not damage the integrity of junction area J. This may be done be a variety of methods, including a metal saw or cutting torch. Install the appropriate left or right side adapter 30 to the each side of frame 10, securing each with a longer replacement shock bolt 18′ , as the shock is reinstalled on both sides. Bushings 28 may be used to gain additional separation between shocks 16, as well as ensure a precise fit of replacement shock bolt 18′ and shock 16 with each adapter 30.

All the essential components for this modification may be packaged in a kit, so that all the parts correctly correspond in size. This includes that the width of adapter 30, the length of replacement shock bolt 18′ correspond to each other, and are intended for use with a specific width wheel and swing arm. Further items to complete the modification, such as components to widen the drive train, as described in U.S. Pat. No. 6,230,837, issued to Soileau, may also be included in a conversion kit. The disclosure of U.S. Pat. No. 6,230,837 is hereby expressly incorporated by reference into this disclosure.

The foregoing disclosure and description of the invention is illustrative and explanatory thereof. Various changes in the details of the illustrated construction may be made within the scope of the appended claims without departing from the spirit of the invention. The present invention should only be limited by the following claims and their legal equivalents.

I claim:

1. A motorcycle frame adapter for a Harley-Davidson(g-style motorcycle frame, said frame having a generally vertical suspension system with, on each side of the motorcycle frame, a rear shock absorber frame bolt hole through a junction point formed by the junction of a generally vertical frame riser and a generally horizontal frame member, said adapter comprising:
an adapter body having an inner surface, an outer surface, and a shock absorber bolt hole;
said inner surface fashioned for frictional contact with said junction point;
said shock absorber bolt hole having an inside diameter slightly larger than a shock absorber bolt, in order to permit passage of said shock absorber bolt through said shock absorber bolt hole; and
said outer surface having a biasing surface near a perimeter of said shock absorber bolt hole for biasing the adapter body against the junction point with a shock absorber bolt.

2. The device of claim 1 further comprising:
said inner surface having a recess correspondingly shaped to receive at least a portion of the junction point, with said rear shock absorber frame bolt hole in alignment with said shock absorber bolt hole.

3. The device of claim 2 further comprising:
said inner surface having an upper shoulder and a lower shoulder.

4. The device of claim 1 further comprising:
said outer surface having a strut attachment point.

5. The device of claim 1 further comprising:
said strut attachment point being a strut attachment bolt hole.

6. A method of adapting a Harley-Davidson®-style motorcycle frame for a wide tire, said frame having a generally vertical suspension system with, on each side of the motorcycle frame, a rear shock absorber frame bolt hole through a junction point formed by the junction of a generally vertical frame riser and a generally horizontal frame member, said method comprising:
positioning a frame adapter outside the junction point on each side of the frame, said adapter having an inner surface, an outer surface, and a shock absorber bolt hole, said inner surface fashioned for frictional contact with said junction point, and to align said shock absorber bolt hole said rear shock absorber frame bolt hole, said shock absorber bolt hole having an inside diameter slightly larger than a shock absorber bolt in order to permit slidable passage of said shock absorber bolt through said shock absorber bolt hole, and said outer surface having a biasing surface near a perimeter of said shock absorber bolt hole for biasing the adapter body against the junction point with the rear shock absorber frame bolt hole in alignment with said shock absorber bolt hole;
positioning a shock absorber bolt of suitable length through the adapter's shock absorber bolt hole, and into an original shock absorber bolt hole in the frame; and
securing the adapter to the frame by appropriately torquing the shock absorber bolt to bias the adapter against the frame.

7. The method of claim 6 further comprising:
said inner surface of said adapter having a recess correspondingly shaped to receive at least a portion of the junction point.

8. The method of claim 7 further comprising:
said inner surface of said adapter having an upper shoulder and a lower shoulder.

9. The method of claim 6 further comprising:
said outer surface of said adapter having a strut attachment point.

10. The method of claim 6 further comprising:
said strut attachment point being a strut attachment bolt hole.

11. The method of claim 6 further comprising:
removing an existing rear shock absorber bolt from said rear shock absorber frame bolt hole prior to positioning said frame adapter outside the junction point.
